(19) United States
(12) Patent Application Publication
(10) Pub. No.: US 2020/0408161 A1
(43) Pub. Date: Dec. 31, 2020

(54) ENGINE SYSTEM

(71) Applicant: AISAN KOGYO KABUSHIKI KAISHA, Obu-shi, Aichi-ken (JP)

(72) Inventors: Takehide NAKAMURA, Obu-shi (JP); Shinji KAWAI, Gifu-shi (JP)

(73) Assignee: AISAN KOGYO KABUSHIKI KAISHA, Obu-shi, Aichi-ken (JP)

(21) Appl. No.: 16/959,591

(22) PCT Filed: Nov. 23, 2018
(86) PCT No.: PCT/JP2018/043302

§ 371 Date: Jul. 1, 2020

(30) Foreign Application Priority Data
Mar. 6, 2018 (JP) 2018-039707

(51) Int. Cl. F02D 41/00; F02M 26/06

(52) U.S. Cl. CPC F02D 41/0007; F02B 37/18; F02M 26/06

(57) ABSTRACT

This engine system is provided with: an engine; an intake passage; an exhaust passage; an electronic throttle device; an EGR device including an EGR valve; a fresh-air flow device including a fresh-air inflow valve; and an ECU. The ECU, in order to throttle intake air to the engine during deceleration of the engine, causes the electronic throttle device to be closed from an open valve state to a predetermined deceleration opening while causing the EGR valve to become closed to shut off introduction of EGR gas into the intake passage, and, in order to introduce fresh air into the intake passage (intake manifold) downstream of the electronic throttle device, causes the fresh-air inflow valve to become opened from the closed valve state at a timing delayed by a predetermined period from the timing of closing the electronic throttle device.

### TECHNICAL FIELD

The technique disclosed in this description relates to an engine system including an engine provided with a supercharger, an intake amount regulation valve for regulating an intake amount of air taken into the engine, a low-pressure loop exhaust gas recirculation apparatus for recirculating the emitted exhaust gas to the engine, and a fresh-air inflow unit for introducing fresh air to a downstream side of the intake amount regulation valve, the system being configured to control the intake amount regulation valve, the exhaust gas recirculation apparatus, and the fresh-air inflow unit during deceleration of the engine.

### BACKGROUND ART

Heretofore, as this type of technique, a “combustion engine” described in the Patent Document 1 mentioned below has been known. In this technique, an intake passage of an engine is provided with a supercharger (compressor), an intake throttle valve provided upstream of the compressor, a throttle valve provided downstream of the compressor, a fresh-air inflow passage connecting an upstream side of the intake throttle valve and a downstream side of the throttle valve, a fresh-air inflow valve provided in the fresh-air inflow passage, and a low-pressure loop EGR apparatus. This technique provides a configuration that, when a requested EGR rate decreases during deceleration of the engine, the intake throttle valve or the fresh-air inflow valve is opened to introduce fresh air to the intake passage downstream of the throttle valve early so that the EGR rate is lowered to prevent misfire on deceleration of the engine.

### RELATED ART DOCUMENTS

### Patent Documents

Patent Document 1: JP2012-007547A

### SUMMARY OF INVENTION

### Problems to be Solved by the Invention

However, in the technique described in the Patent Document 1, during deceleration of the engine, especially during deceleration from a supercharging state (in a transition time of the engine from a highly-loaded state to a low-loaded state), valve-opening of the fresh-air inflow valve at the almost same time with valve-closing of the throttle valve may cause backflow of the air including EGR gas from the intake passage through a fresh-air inflow passage to its inlet port (the intake passage upstream of the intake throttle valve) due to residual supercharging pressure remaining in the intake passage. In this case, the EGR gas having flown backward may disturb a post-deceleration EGR rate. Further, in another case that an air flowmeter is provided in a vicinity of the inlet port of the fresh-air inflow passage, the air flowmeter may be defaced or spoiled by the EGR gas, and that may cause degradation in the performance of the air flowmeter.

This disclosed technique has been made in view of the above circumstances and has a purpose of providing an engine system achieving prevention of backflow of an exhaust recirculation gas to an inlet and its vicinity of a fresh-air inflow passage even when a fresh-air inflow valve is opened during deceleration of an engine, especially during deceleration from a supercharging state.

### Means of Solving the Problems

(1) To achieve the above purpose, one aspect of the invention provides an engine system comprising: an engine; an intake passage configured to introduce intake air into the engine; an exhaust passage configured to allow exhaust gas to flow out of the engine; a supercharger provided in the intake passage and the exhaust passage to increase pressure of the intake air in the intake passage, the supercharger including a compressor placed in the intake passage, a turbine placed in the exhaust passage, and a rotary shaft integrally rotatably connecting the compressor and the turbine; an intake amount regulation valve placed in the intake passage downstream of the compressor to regulate an intake amount of the intake air flowing in the intake passage; an exhaust gas recirculation apparatus including an exhaust gas recirculation passage configured to allow a part of the exhaust gas discharged from the engine to the exhaust passage to flow in the intake passage as exhaust gas recirculation gas and an exhaust gas recirculation valve configured to regulate an exhaust gas recirculation flow rate in the exhaust gas recirculation passage, the exhaust gas recirculation passage having an inlet connected to the exhaust passage downstream of the turbine and an outlet connected to the intake passage upstream of the compressor; a fresh-air inflow unit including a fresh-air inflow passage configured to introduce fresh air to the intake passage downstream of the intake amount regulation valve and a fresh-air inflow valve configured to regulate a fresh air amount of fresh air flowing in the fresh-air inflow passage, the fresh-air inflow passage having an inlet port connected to the intake passage upstream of the outlet of the exhaust gas recirculation passage; an operation state detection member configured to detect an operation state of the engine; and a control unit configured to control at least the intake amount regulation valve, the exhaust gas recirculation valve, and the fresh-air inflow valve based on the detected operation state of the engine, wherein the control unit is configured to close the intake amount regulation valve to a predetermined deceleration open degree from a valve open state so that the intake amount of the intake air to the engine is narrowed, to close the exhaust gas recirculation valve so that the inflow of the exhaust gas recirculation gas to the intake passage is shut off, and to open the fresh-air inflow valve from the valve closed state at a timing delayed by a predetermined period of time from a timing of closing the intake amount regulation valve so that a fresh air is introduced into the intake passage downstream of the intake amount regulation valve.

According to the above configuration (1), during deceleration of the engine, the intake amount regulation valve is closed to the predetermined deceleration open degree from the valve open state in order to throttle down the intake amount to the engine, and the exhaust gas recirculation valve is closed in order to shut off an inflow of the exhaust gas recirculation gas into the intake passage. At this time, the exhaust gas recirculation gas, which has flown into the intake passage before the EGR gas inflow into the intake passage is shut off, remains in the intake passage upstream of the intake amount regulation valve, and the air including the thus remaining exhaust gas recirculation gas flows in the intake passage downstream of the intake amount regulation valve and is sucked into the engine, so that misfire on the engine may occur. According to the above configuration, during deceleration of the engine, the fresh-air inflow valve is opened from the valve-closed state to introduce the fresh air into the intake passage downstream of the intake amount regulation valve. Accordingly, even when the air including the exhaust gas recirculation gas flows in the intake passage downstream of the intake amount regulation valve, the exhaust gas recirculation gas is compulsively diluted by the fresh air introduced into that part of the intake passage from the fresh-air inflow passage. The fresh-air inflow valve is opened at the timing delayed by the predetermined period of time from the timing of closing the intake amount regulation valve, so that the residual supercharging pressure in the intake passage decreases when the fresh-air inflow valve is to be opened especially during deceleration from the supercharging state, thereby restraining backflow of the air including the exhaust gas recirculation gas from the intake passage to the fresh-air inflow passage.

(2) In order to achieve the above purpose, in the configuration of the above (1), the engine system further comprises an intake pressure detection member for detecting an intake pressure in the intake passage downstream of the intake amount regulation valve, and the control unit is configured to calculate the predetermined period of time for delaying valve-opening of the fresh-air inflow valve based on the detected intake pressure, a volume of the intake passage downstream of the intake amount regulation valve, and a volume of the fresh-air inflow passage.

According to the above configuration (2), in addition to the operation of the above configuration (1), the predetermined period of time for delaying valve-opening of the fresh-air inflow valve is calculated based on the intake pressure in the intake passage downstream of the intake amount regulation valve, the volume of that part of the intake passage, and the volume of the fresh-air inflow passage. Accordingly, the timing of opening the fresh-air inflow valve is determined according to a height of the residual supercharging pressure in the intake passage downstream of the intake amount regulation valve.

(3) In order to achieve the above purpose, in the above configuration (1) or (2), the engine system is provided with a chamber having a predetermined volume in the fresh-air inflow passage upstream of the fresh-air inflow valve.

According to the above configuration (3), in addition to the operation of the above configuration (1) or (2), the exhaust gas recirculation gas that has flown backward into the fresh-air inflow passage from the intake passage is captured in the chamber. Further, the residual supercharging pressure in the intake passage decreases by the volume of the chamber in the fresh-air inflow passage.

(4) In order to achieve the above purpose, in the above configuration (3), the engine system further comprises: an intake bypass passage bypassing an upstream side and a downstream side of the compressor; and an intake bypass valve to open and close the intake bypass passage, and the control unit is configured to open the fresh-air inflow valve from the valve-closed state on or prior to start of valve opening of the intake bypass valve.

According to the above configuration (4), in addition to the operation of the above configuration (3), the fresh-air inflow valve is opened from its valve-closed state prior to (or concurrently with) start opening the intake bypass valve, and owing to installation of a chamber in the fresh-air inflow passage, the fresh-air inflow valve can be opened relatively early by the volume of the chamber.

In order to achieve the above purpose, in any one of the above configuration (1) to (3), the engine system further comprises: an intake bypass passage bypassing an upstream side and a downstream side of the compressor; and an intake bypass valve configured to open and close the intake bypass passage, and the control unit is configured to open the fresh-air inflow valve from the valve-closed state after start of valve-opening of the intake bypass valve.

According to the above configuration (5), in addition to the operation of any one of the above configurations (1) to (3), the fresh-air inflow valve is opened from the valve-closed state after start of opening the intake bypass valve, and thus the fresh-air inflow valve can be opened after the intake pressure in the intake passage is decreased by opening the intake bypass valve.

### Effects of the Invention

According to the above configuration (1), even if the fresh-air inflow valve is opened during deceleration of the engine, especially during deceleration from the supercharging state, it is possible to restrain backflow of the exhaust gas recirculation gas to the inlet and its vicinity of the fresh-air inflow passage.

According to the above configuration (2), in addition to the effect of the above configuration (1), it is possible to finely restrain backflow of the exhaust gas recirculation gas to the inlet and its vicinity of the fresh-air inflow passage in accordance with a height of the residual supercharging pressure in the intake passage downstream of the intake amount regulation valve.

According to the above configuration (3), in addition to the effect of the above configuration (1) or (2), it is possible to further assuredly restrain backflow of the exhaust gas recirculation gas to the inlet and its vicinity of the fresh-air inflow passage.

According to the above configuration (4), in addition to the effect of the above configuration (3), the fresh air can be introduced into the intake passage relatively early without causing backflow of the exhaust gas recirculation gas from the intake passage to the fresh-air inflow passage, and thereby it is possible to lower the exhaust gas recirculation rate (EGR rate) relatively early, so that misfire on deceleration of the engine can be prevented.

According to the above configuration (5), in addition to the effect of any one of the above configurations (1) to (3), it is possible to restrain backflow of the exhaust gas recirculation gas from the intake passage to the fresh-air inflow passage. Further, when a chamber is provided in the fresh-air inflow passage, a volume of the chamber can be made downsized.

### BRIEF DESCRIPTION OF THE DRAWINGS

FIG. 1 is a schematic configurational view showing an engine system in a first embodiment;

FIG. 2 is a flowchart showing a control content of a fresh-air inflow control during deceleration of an engine in the first embodiment;

FIG. 3 is a first map of delayed time for valve-opening illustrating a relation of an intake pressure and a first delayed time for valve-opening with respect to a first volume in a fresh-air inflow passage and others in the first embodiment;

FIG. 4 is a second map of delayed time for valve-opening illustrating a relation of the intake pressure and a second delayed time for valve-opening with respect to a second volume in an intake manifold and others in the first embodiment;

FIG. 5 is a graph showing a relation of a chamber volume, an EGR rate, and a delayed time from valve-closing of an electronic throttle device to valve-opening of the fresh-air inflow valve;

FIG. 6 is a flowchart showing a control content of the fresh-air inflow control during deceleration of the engine in a second embodiment;

FIG. 7 is a time chart showing behavior of various parameters of the fresh-air inflow control in the second embodiment;

FIG. 8 is a graph showing changes in the EGR rate before and after deceleration of the engine in the second embodiment;

FIG. 9 is a time chart showing behavior of various parameters in an engine control in the second embodiment; and

FIG. 10 is a graph showing changes in the EGR rate in each one of cases (C1) to (C3) in the second embodiment.

### MODE FOR CARRYING OUT THE INVENTION

### First Embodiment

A detailed description of a first embodiment embodying an engine system will now be given with reference to the accompanying drawings.

(Overview of Configuration of Engine System)

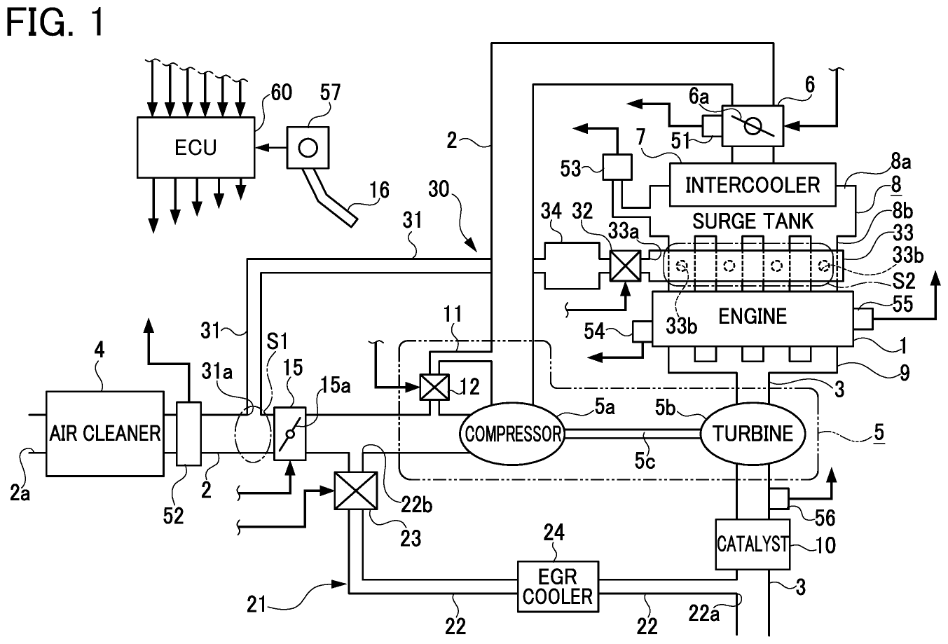

FIG. 1 is a schematic configurational view of an engine system according to the present embodiment. A gasoline engine system (hereinafter, simply referred to an “engine system”) mounted in an automobile includes an engine 1 provided with a plurality of cylinders. This engine 1 is a four-stroke cycle reciprocating engine with four cylinders and includes known components such as a piston and a crankshaft. The engine 1 is provided with an intake passage 2 to introduce intake air into each cylinder and an exhaust passage 3 to allow exhaust gas to flow out of each cylinder. A supercharger 5 is provided in a position between the intake passage 2 and the exhaust passage 3. The intake passage 2 is provided with an intake port 2a, an air cleaner 4, an intake throttle valve 15, a compressor 5a of the supercharger 5, an electronic throttle device 6, an intercooler 7, and an intake manifold 8 in this order from an upstream side.

The electronic throttle device 6 is placed in the intake passage 2 upstream of the intake manifold 8 and the intercooler 7 to be driven to open and close in accordance with operation of an accelerator pedal operated by a driver so that an intake flow rate of intake air flowing in the intake passage 2 is regulated. The electronic throttle device 6 in the present embodiment is constituted by a motor-operated electric valve and includes a throttle valve 6a that is driven to be open and closed by a motor (not shown) and a throttle sensor 51 to detect an open degree (a throttle open degree) TA of the throttle valve 6a. The electronic throttle device 6 corresponds to one example of an intake amount regulation valve of the disclosed technique. The intake manifold 8 is placed directly upstream of the engine 1 and includes a surge tank 8a to introduce the intake air and a plurality of (four) branch pipes 8b to distribute the intake air introduced in the surge tank 8a to each cylinder of the engine 1. The exhaust passage 3 is provided with an exhaust manifold 9, a turbine 5b of the supercharger 5, and a catalyst 10 in this order from an upstream side. The catalyst 10 is provided to purify the exhaust gas and constituted by three-way catalyst, for example.

The supercharger 5 for increasing pressure of the intake air in the intake passage 2 includes the compressor 5a placed in the intake passage 2, the turbine 5b placed in the exhaust passage 3, and a rotary shaft 5c connecting the compressor 5a and the turbine 5b in an integrally rotatable manner. The turbine 5b is operated to rotate by the flow of the exhaust gas flowing in the exhaust passage 3, and then the compressor 5a is operated to rotate in association with that rotation of the turbine 5b, so that the pressure of the intake air flowing in the intake passage 2 is made to increase its pressure. The supercharger 5 is further provided with an intake bypass passage 11 to bypass an upstream side and a downstream side of the compressor 5a. This intake bypass passage 11 is provided with an intake bypass valve 12 to open and close the passage 11. The intercooler 7 cools down the intake air that has been increased its pressure by the compressor 5a.

(Configuration of EGR Device)

This engine system of the present embodiment is provided with a low-pressure-loop type exhaust gas recirculation apparatus (EGR apparatus) 21. This EGR apparatus 21 is provided with an exhaust gas recirculation passage (EGR passage) 22 to allow a part of the exhaust gas, which has been flown out of each cylinder to the exhaust passage 3 as the exhaust gas recirculation gas (EGR gas), to flow into the intake passage 2 so as to further recirculate the gas into each cylinder of the engine 1, and an exhaust gas recirculation valve (EGR valve) 23 to regulate an EGR gas flow rate in the EGR passage 22. The EGR passage 22 includes an inlet 22a and an outlet 22b. The inlet 22a of the EGR passage 22 is connected to the exhaust passage 3 downstream of the catalyst 10, and the outlet 22b of the passage 22 is connected to the intake passage 2 between the compressor 5a and the intake throttle valve 15. Further, in the EGR passage 22 upstream of the EGR valve 23, an EGR cooler 24 for cooling down the EGR gas is provided.

The EGR valve 23 of the present embodiment is constituted by a motor-operated electric valve including a valve element (not shown) that is driven by a motor (not shown) to be changeable in its open degree. This EGR valve 23 has preferably characteristics of a large flow rate, high responsivity, and high resolution. In this embodiment, “a double eccentric valve” described in JP Patent No. 5759646 may be adopted as a configuration of the EGR valve 23, for example. This double eccentric valve is configured to deal with a large flow rate control.

In a supercharging region where the supercharger 5 is operated (where the inflow rate is relatively large) in this engine system, the EGR valve 23 is opened. Thus, the part of the exhaust gas flowing in the exhaust passage 3 flows into the EGR passage 22 as the EGR gas from the inlet port 22a, further flows in the intake passage 2 via the EGR cooler 24 and the EGR valve 23, and then recirculate into each cylinder of the engine 1 through the compressor 5a, the electronic throttle device 6, the intercooler 7, and the intake manifold 8.

In this embodiment, the intake passage 2 downstream of the air cleaner 4 and upstream of the outlet port 22b of the EGR passage 22 is provided with an intake throttle valve 15 to narrow a passage area of the intake passage 2. The intake throttle valve 15 of the present embodiment is constituted by a motor-operated electric valve and includes a butterfly valve 15a to be driven to open and close. This intake throttle valve 15 is made to narrow an open degree of the butterfly valve 15a to turn the intake air near the outlet port 22b into the negative pressure when the EGR gas is to be introduced in the intake passage 2 from the outlet port 22b of the EGR passage 22.

(Configuration of Fresh-Air Inflow Device)

The engine system of the present embodiment includes a fresh-air inflow device 30 to introduce fresh air to the intake passage 2 (the intake manifold 8) downstream of the electronic throttle device 6. The fresh-air inflow device 30 is provided with a fresh-air inflow passage 31 and an electrically-operated fresh-air inflow valve 32. The fresh-air inflow passage 31 includes an inlet 31a that is connected to the intake passage 2 upstream of the intake throttle valve 15. The fresh-air inflow valve 32 is provided in the vicinity of an outlet side of the fresh-air inflow passage 31 to regulate a flow rate of the fresh air flowing into the intake passage 2 from the passage 31. On the outlet side of the fresh-air inflow passage 31, a fresh air distribution pipe 33 to distribute the fresh air to each of the branch pipes 8b of the intake manifold 8 is provided. To be specific, the outlet side of the fresh-air inflow passage 31 is connected to the intake manifold 8 via the fresh air distribution pipe 33. The fresh air distribution pipe 33 of a long pipe-like shape is placed in the intake manifold 8 to extend across a plurality of the branch pipes 8b. The fresh air distribution pipe 33 includes one inlet port 33a in which the fresh air is introduced and a plurality of outlet ports 33b communicated with a plurality of the branch pipes 8b, respectively. The inlet port 33a is connected with the outlet side of the fresh-air inflow passage 31. In the fresh-air inflow passage 31 upstream of the fresh-air inflow valve 32, a fresh air chamber 34 is provided to enlarge a volume of a part of the passage 31.

(Electrical Configuration of Engine System)

An electrical configuration of the engine system is now explained. As shown in FIG. 1, various sensors 51 to 57 provided in this engine system correspond to one example of an operation state detection member of this disclosed technique to detect an operation state of the engine 1. A throttle sensor 51 provided in the electronic throttle device 6 detects a throttle open degree TA and outputs an electrical signal corresponding to the detected value. An air flowmeter 52 provided near the air cleaner 4 detects an intake amount Ga of air flowing in the intake passage 2 from the air cleaner 4 and outputs an electrical signal corresponding to the detected value. An intake pressure sensor 53 provided in the surge tank 8a detects an intake pressure PM downstream of the electronic throttle device 6 and outputs an electrical signal corresponding to the detected value. The intake pressure sensor 53 corresponds to one example of an intake pressure detection member of the disclosed technique. A water temperature sensor 54 provided in the engine 1 detects a temperature (coolant temperature) THW of a coolant flowing inside the engine 1 and outputs an electrical signal corresponding to the detected value. A rotation speed sensor 55 provided in the engine 1 detects rotation speed of a crank shaft (not shown) as a rotation speed (engine rotation speed) NE of the engine 1 and outputs an electrical signal corresponding to the detected value. An oxygen sensor 56 provided in the exhaust passage 3 detects oxygen concentration (output voltage) Ox in the exhaust air discharged to the exhaust passage 3 and outputs an electrical signal corresponding to the detected value. An accelerator pedal 16 provided in a driver's seat is provided with an accelerator sensor 57. The accelerator sensor 57 detects a pressed angle of the accelerator pedal 16 as an accelerator open degree ACC and outputs an electric signal corresponding to the detected value.

This engine system further includes an electronic control unit (ECU) 60 taking in charge of various control operations. To the ECU 60, each of the various sensors 51 to 57 and others are connected. Further to the ECU 60, the electronic throttle device 6, the intake bypass valve 12, the intake throttle valve 15, the EGR valve 23, and the fresh-air inflow valve 32 are each connected. The ECU 60 corresponds to one example of a control unit of the disclosed technique.

In the present embodiment, the ECU 60 takes every signal that is output from the various sensors 51 to 57 and controls the respective components of the electronic throttle device 6, the intake bypass valve, 12, the intake throttle valve 15, the EGR valve 23, and the fresh-air inflow valve 32 to carry out intake control, EGR control, fresh-air inflow control, and others based on those input signals.

The intake control stands for regulating the intake amount of the intake air introduced in the engine 1 by controlling the electronic throttle device 6 based on the value detected by the accelerator sensor 57 according to the driver's operation of the accelerator pedal 16. During deceleration of the engine 1, the ECU 60 is made to control the electronic throttle device 6 (the throttle valve 6a) to be brought in a valve closing direction so that the intake amount of the intake air into the engine 1 is narrowed. The EGR control stands for regulating the flow rate of the EGR gas recirculated into the engine 1 by controlling the EGR valve 23 according to the operation state of the engine 1. The ECU 60 is made to control the EGR valve 23 to be fully closed during deceleration of the engine 1 so that recirculation of the EGR gas is shut off (EGR cut-off). The fresh-air inflow control stands for regulating an inflow amount of the fresh air introduced in the intake manifold 8 by controlling the fresh-air inflow valve 32 according to the operation state of the engine 1.

As well known, the ECU 60 includes a central processing unit (CPU), various memories, an external input circuit, an external output circuit, and others. Each memory stores predetermined control program related to each control operation of the engine 1. The CPU is to carry out the above-mentioned various control operations according to the predetermined control programs based on the detected values that are input by the various sensors 51 to 57 through the input circuit.

In the above-mentioned engine system, when the fresh-air inflow valve 32 is opened at the almost same time with valve closing of the electronic throttle device 6 (the throttle valve 6a) during deceleration of the engine 1, especially during deceleration form the supercharging state, the air including the EGR gas may flow backward to the inlet port 31a and its vicinity via the fresh-air inflow passage 31 from the intake manifold 8 due to the residual supercharging pressure remaining in the intake passage 2. To address the above problem, in the present embodiment, the following fresh-air inflow control is made to be performed during deceleration of the engine 1.

(Fresh-Air Inflow Control During Engine Deceleration)

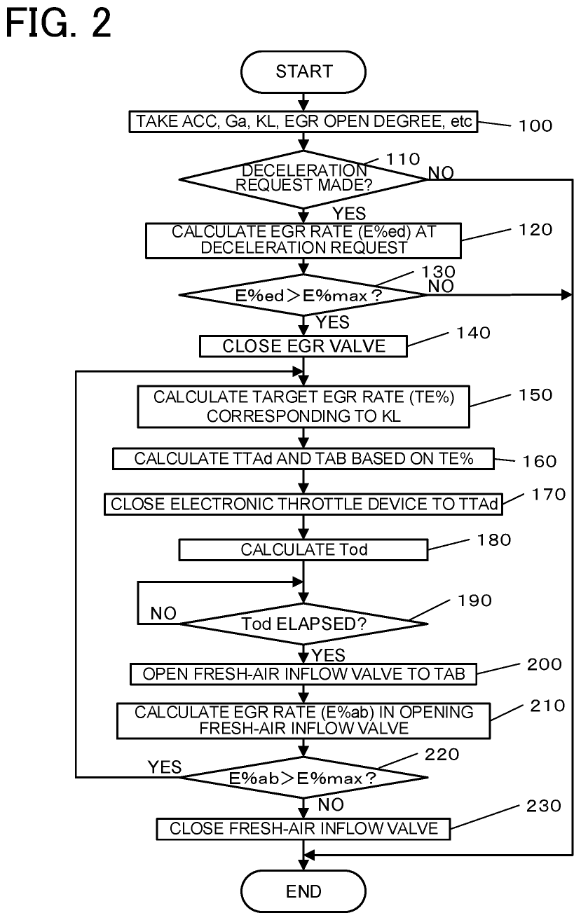

Next, a fresh-air inflow control during deceleration of the engine is explained. This control content is shown in a flowchart of FIG. 2.

When the process proceeds to this routine, in step 100, the ECU 60 takes the accelerator open degree ACC, the intake amount Ga, and an engine load KL from the various sensors 51 to 53, and 57, respectively, and further takes an open degree (an EGR open degree) of the EGR valve 23 under control.

Subsequently, in step 110, the ECU 60 determines whether a request for deceleration of the engine 1 has been made. The ECU 60 is enabled to make this determination based on the accelerator open degree ACC. The ECU 60 proceeds to step 120 when this determination result is affirmative, or once terminates the following process when this determination result is negative.

In step 120, the ECU 60 calculates an EGR rate E % ed at the time of deceleration request. The ECU 60 obtains this EGR rate E % ed, for example, based on the intake amount Ga and the EGR open degree at the time of receiving the deceleration request.

Subsequently, in step 130, the ECU 60 determines whether the EGR rate E % ed is larger than an EGR rate E % max at misfire limit, namely, determines whether the EGR rate E % ed exceeds the misfire limit. The ECU 60 proceeds the process to step 140 when this determination result is affirmative, or once terminates the process when this determination result is negative.

In step 140, the ECU 60 closes the EGR valve 23 to shut off the EGR gas.

Subsequently, in step 150, the ECU 60 calculates a target EGR rate TE % corresponding to the engine load KL. The ECU 60 obtains the target EGR rate TE % corresponding to the engine load KL by referring to a predetermined target EGR rate map, for example.

Subsequently, in step 160, the ECU 60 calculates a target deceleration open-degree TTAd and a target fresh-air open-degree TAB based on the target EGR rate TE %. The ECU 60 obtains each of the target deceleration open-degree TTAd and the target fresh-air open-degree TAB corresponding to the target EGR rate TE % by referring to a predetermined target deceleration open-degree map and a predetermined target fresh-air open-degree map, for example

Subsequently, in step 170, the ECU 60 closes the electronic throttle device 6 to the target deceleration open degree TTAd. In other words, the ECU 60 closes the electronic throttle device 6 to the target deceleration open degree TTAd in order to narrow the intake amount of the intake air to the engine 1 during deceleration.

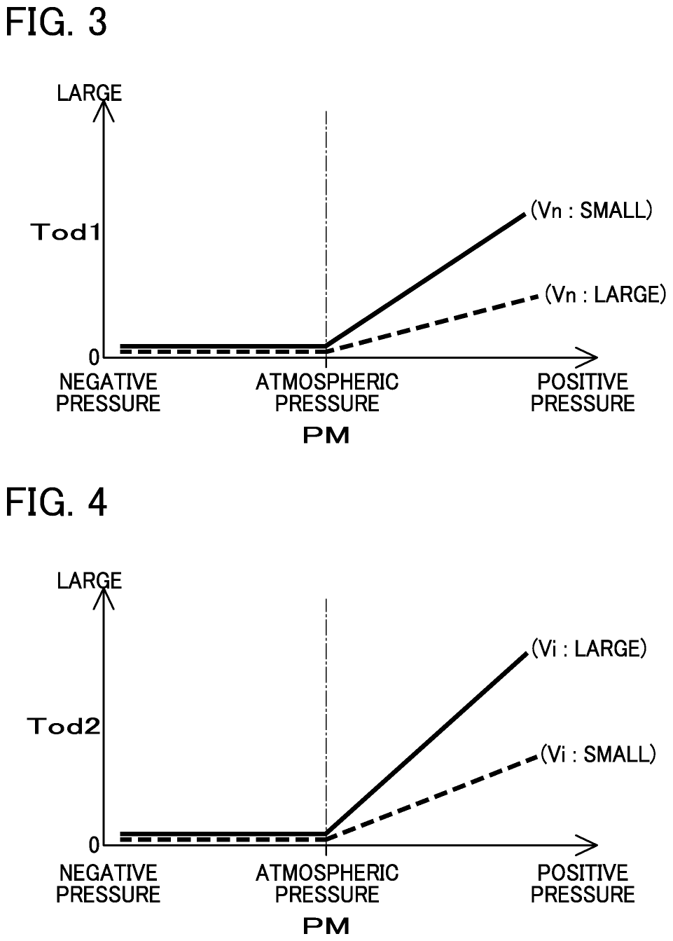

Subsequently, in step 180, the ECU 60 calculates a delayed time for valve-opening Tod. The ECU 60 obtains the delayed time for valve-opening Tod based on a volume of the intake passage 2 (the intake manifold 8) downstream of the electronic throttle device 6, a volume of the fresh-air inflow passage 31, and the detected intake pressure PM, for example. Herein, the volume of the intake manifold 8 and the volume of the fresh-air inflow passage 31 are each unchanged, but the intake pressure PM changes depending on the operation state of the engine 1. Further, a relation of the intake manifold 8 to the intake pressure PM and a relation of the volume of the fresh-air inflow passage 31 to the intake pressure PM are different from each other. Accordingly, the ECU 60 is made to obtain a first delayed time for valve-opening Tod1 and a second delayed time for valve-opening Tod2 corresponding to the intake pressure PM by referring to a predetermined first map of delayed time for valve-opening (FIG. 3) that is set according to the volume of the fresh-air inflow passage 31 and a predetermined second map of delayed time for valve-opening (FIG. 4) that is set according to the volume of the intake manifold 8 and others, and then the ECU 60 obtains the final delayed time for valve-opening Tod based on those values. FIG. 3 shows the first map of delayed time for valve-opening illustrating a relation of the intake pressure PM and the first delayed time for valve-opening Tod1 with respect to the volume (a first volume) Vn of the fresh-air inflow passage 31 upstream of the fresh-air inflow valve 32 including the fresh air chamber 34. In this map, the first delayed time for valve-opening is set to be larger as the first volume Vn becomes smaller. FIG. 4 shows the second map of delayed time for valve-opening illustrating a relation of the intake pressure PM and the second delayed time for valve-opening Tod2 with respect to the volume (a second volume) Vi of a passage downstream of the fresh-air inflow valve 32 and the intake passage 2 (the intake manifold 8) downstream of the electronic throttle device 6. In this map, the second delayed time for valve-opening Tod2 is set to be larger as the second volume Vi becomes larger. Herein, the ECU 60 obtains the second delayed time for valve-opening Tod2 as a basis in correspondence with the volume of the intake manifold 8 and others by referring to the second map of delayed time for valve-opening. Further, the ECU 60 obtains the first delayed time for valve-opening Tod1 in correspondence with the volume of the fresh-air inflow passage 31 and others by referring to the first map of delayed time for valve-opening. The ECU 60 further makes correction to the second delayed time for valve-opening Tod2 according to the first delayed time for valve-opening Tod1 to obtain the final delayed time for valve-opening Tod. For example, in a case when there is needed a determined time (time of delay) for the intake pressure PM to decrease to a predetermined value because of the volume of the intake manifold 8 and others (Tod2>0), the delayed time for valve-opening Tod can be “0” when the volume of the fresh-air inflow passage 31 is large enough (the passage 31 can store enough intake air that may cause backflow).

Subsequently, in step 190, the ECU 60 waits for elapse of the calculated delayed time for valve-opening Tod and then proceeds to step 200 to open the fresh-air inflow valve 32 to a target fresh-air open-degree TAB. Thus, after valve-closing of the electronic throttle valve 6, the fresh-air inflow valve 32 is opened to the target fresh-air open-degree TAB from the valve-closed state by the delay of a predetermined time.

Subsequently, in step 210, the ECU 60 calculates an EGR rate E % ab at the time of opening the fresh-air inflow valve 32. The ECU 60 obtains the EGR rate E % ab corresponding to the detected intake pressure PM by referring to the predetermined EGR rate map, for example.

Subsequently, in step 220, the ECU 60 determines whether this EGR rate E % ab is larger than the misfire limit of the EGR rate E % max, namely, determines whether the EGR rate E % ab exceeds the misfire limit. The ECU 60 returns the process to step 150 when this determination result is affirmative, or proceeds to step 230 when this determination result is negative.

In step 230, the ECU 60 closes the fresh-air inflow valve 32 and once terminates the following process.

According to the above control, the ECU 60 closes the electronic throttle device 6 to the predetermined target deceleration open degree TTAd from the valve-open state so that the intake amount of the intake air to the engine 1 is narrowed, closes the EGR valve 32 to shut off the inflow of the EGR gas to the intake passage 2, and opens the fresh-air inflow valve 32 from the valve-closed state at the timing delayed from the timing of closing the electronic throttle valve 6 by the predetermined delayed time for valve-opening Tod so that the fresh air is introduced to the intake passage 2 (intake manifold 8) downstream of the electronic throttle valve 6.

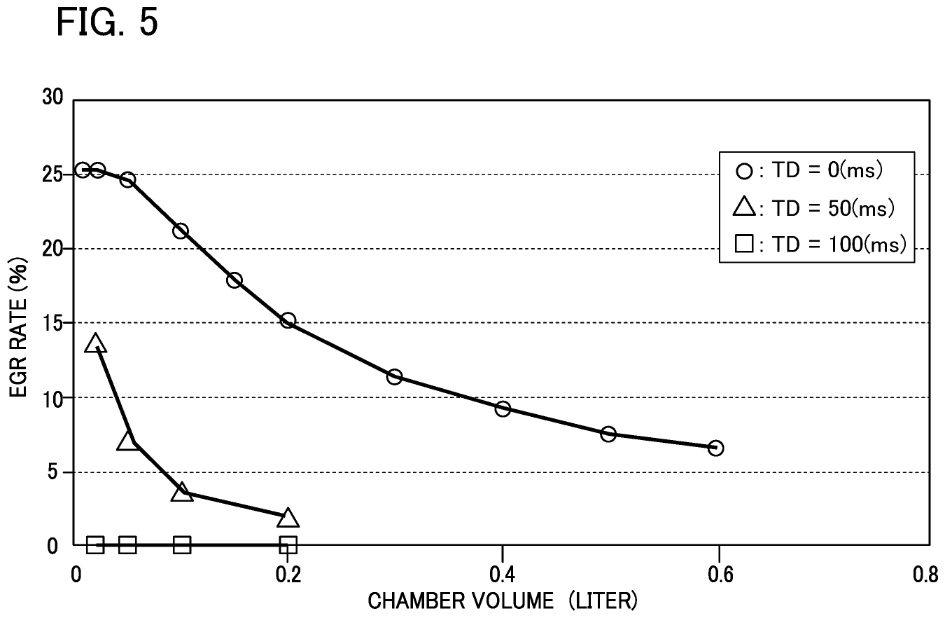

FIG. 5 is a graph showing a relation among a volume (a chamber volume) of the fresh air chamber 34, the EGR rate, and a “time of delay TD” from valve-closing of the electronic throttle device 6 to valve-opening of the fresh-air inflow valve 32. The EGR rate in this situation stands for a degree of backflow of the EGR gas to the inlet port 31a and its vicinity of the fresh-air inflow passage 31 (a portion indicated with a chain-dot oblong S1 in FIG. 1). In FIG. 5, a “circle mark” indicates an example of the “time of delay TD” as “0 (ms)”, a “triangle mark” indicates another example of the “time of delay TD” as “50 (ms)”, and a “square mark” indicates another example of the “time of delay TD” as “100 (ms)”, respectively. In the example of the “time of delay” being “0 (ms)”, the EGR rate decreases in a range of “25 to 7(%)” as the chamber volume increases in a range of “about 0 to 0.6 (liter).” In the example of the “time of delay” being “50 (ms)”, the EGR rate decreases in the range of “14 to 2(%)” as the chamber volume increases in the range of “about 0 to 0.2 (liter).” In the example of the “time of delay” being “100 (ms)”, the EGR rate remains unchanged as “0(%)” even when the chamber volume increases in the range of “about 0 to 0.2 (liter).” This graphs tells that, when the valve-closing timing of the electronic throttle device 6 and the valve-opening timing of the fresh-air inflow valve 32 are same, the backflow of the EGR gas to the inlet port 31a and its vicinity occurs even if the chamber volume is increased to “0.6 (liter).” Further, when the “time of delay” is set to “50 (ms)”, the backflow of the EGR gas to the inlet port 31a and its vicinity is considered to be prevented by arranging the chamber volume to be “about 0.2 to 0.3 (liter).” On the other hand, when the “time of delay” is set to “100 (ms)”, there is no backflow of the EGR gas irrespective of presence or absence of the chamber volume. From this relation, the size of the chamber volume can be decided.

(Operations and Effects of Fresh-Air Inflow Control)

According to the above-explained engine system of the present embodiment, during deceleration of the engine 1, the electronic throttle device 6 (the throttle valve 6a) is closed to the predetermined target deceleration open degree TTAd from the valve-open state so that the intake amount of the intake air to the engine 1 is narrowed, and the EGR valve 23 is closed to shut off inflow of the EGR gas to the intake passage 2. At this time, the EGR gas having flown before shut-off of inflow to the intake passage 2 remains in the intake passage 2 upstream of the electronic throttle device 6, and the air including the thus remaining EGR gas flows through the intake passage 2 (the intake manifold 8) downstream of the electronic throttle device 6 to be taken into the engine 1, that may cause misfire on the engine 1. According to the above fresh-air inflow control, during deceleration of the engine 1, the fresh-air inflow valve 32 is made to open from the valve-closed state so that the fresh air is introduced into the intake manifold 8. Accordingly, even if the air including the EGR gas flows in the intake manifold 8, the EGR gas is compulsively diluted by the fresh air that is introduced into that part of the intake manifold 8 from the fresh-air inflow passage 31. Owing to this dilution, a ratio of the EGR gas taken into the engine 1 (the EGR rate) decreases, and thus occurrence of misfire on the engine 1 can be restrained. Herein, the fresh-air inflow valve 32 is to be opened at the timing delayed from the timing of closing the electronic throttle device 6 by a predetermined period of time (the delayed time for valve-opening Tod), and as a result of this, especially during deceleration from the supercharging state, the residual supercharging pressure in the intake passage 2 decreases by the time when the fresh-air inflow valve 32 is opened, so that the air including the EGR gas is prevented from its backflow to the fresh-air inflow passage 31 from the intake manifold 8. Therefore, even when the fresh-air inflow valve 32 is opened during deceleration of the engine 1, especially during deceleration from the supercharging state, the EGR gas can be restrained from its backflow to the inlet port 31a and its vicinity of the fresh-air inflow passage 31. As a consequence, the EGR rate after deceleration can be prevented from its disturbance due to the EGR gas flowing backward. Further, it is possible to restrain the air flowmeter 52 from getting defaced or spoiled by the EGR gas flowing backward, thereby preventing degradation in the performance of the air flowmeter 52 due to the defacement.

According to the configuration of the present embodiment, the predetermined delayed time for valve-opening Tod for delaying valve-opening of the fresh-air inflow valve 32 is calculated based on the intake pressure PM in the intake manifold 8, the volume of that part, and the volume of the fresh-air inflow passage 31. Accordingly, the valve-opening timing of opening the fresh-air inflow valve 32 is determined according to the height of the residual supercharging pressure in the intake manifold 8. Therefore, according to the height of the residual supercharging pressure in the intake manifold 8, the backflow of the EGR gas to the inlet port 31a and its vicinity of the fresh-air inflow passage 31 can be finely restrained.

According to the configuration of the present embodiment, the EGR gas that has flown backward to the fresh-air inflow passage 31 from the intake manifold 8 is captured in the fresh air chamber 34. Further, the residual supercharging pressure in the intake passage 2 (the intake manifold 8) is reduced by the volume of the fresh air chamber 34 in the fresh-air inflow passage 31. Therefore, it is further assuredly possible to restrain backflow of the EGR gas to the inlet port 31a and its vicinity of the fresh-air inflow passage 31.

### Second Embodiment

Next, a second embodiment embodying an engine system will now be explained in detail with reference to the accompanying drawings.

Herein, in the following explanation, similar or identical components to those of the first embodiment are assigned with the same reference signs as in the first embodiment and omitted their explanations, and the following explanation will be made with a focus on differences from the first embodiment.

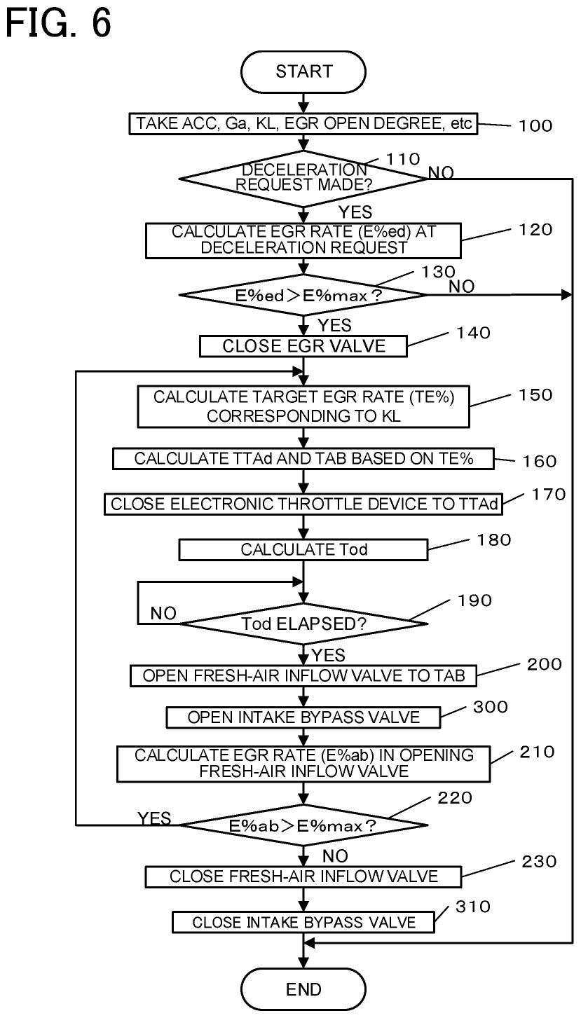

The present embodiment is different from the first embodiment in a content of the fresh-air inflow control during deceleration of the engine. FIG. 6 is a flowchart of the control contents. This flowchart is different from the one in FIG. 2 in a manner that a process of step 300 is provided between step 200 and step 210, and a process of step 310 is provided after step 230.

(Fresh-Air Inflow Control During Engine Deceleration)

When the process proceeds to this routine, the ECU 60 carries out the processes of step 100 to step 200, and then in step 300, opens the intake bypass valve 12.

After that, the ECU 60 carries out the processes of step 210 to step 230, and then in step 310, closes the intake bypass valve 12.

According to the above control, the ECU 60 opens the fresh-air inflow valve 32 prior to (or concurrently with) start of valve-opening of the intake bypass valve 12 in addition to the control processes indicated in the flowchart of FIG. 2.

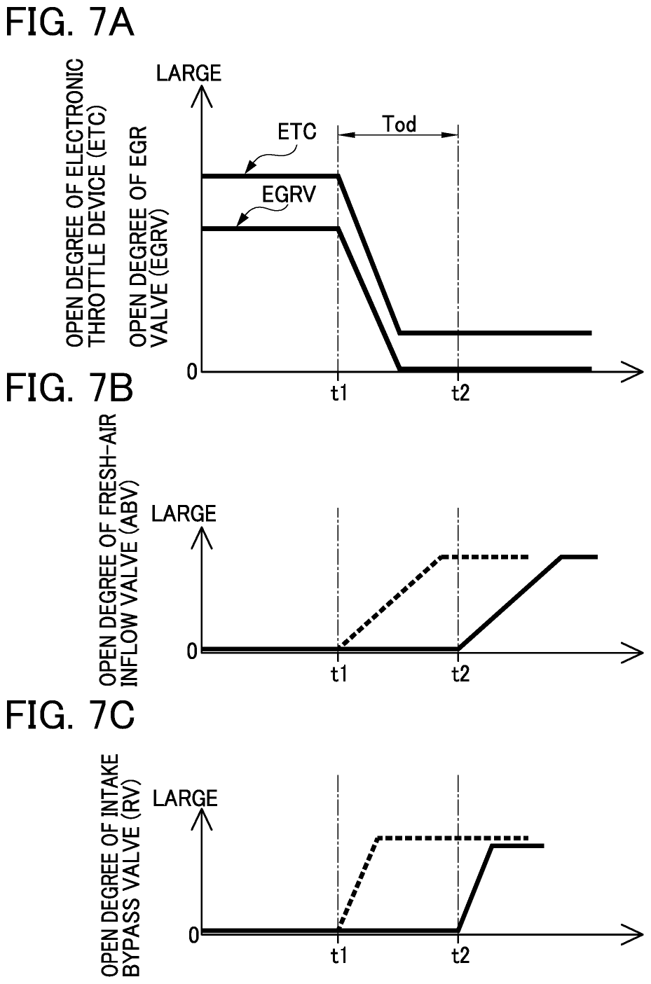

FIG. 7 is a time chart showing behavior of various parameters related to the above control operation. In FIG. 7, (a) indicates open degrees of the electronic throttle device 6 and the EGR valve 23, (b) indicates an open degree of the fresh-air inflow valve 32, and (c) indicates an open degree of the intake bypass valve 12. In FIG. 7, solid lines (bold lines) each indicate behavior of the respective valves 6, 23, 32, and 12, broken lines in (b) and (c) of FIG. 7 each indicate conventional behavior of the respective valves 32 and 12. In FIG. 7, when a request for deceleration is made at time t1 during operation of the engine 1, the electronic throttle device 6 and the EGR valve 23 start to close from the valve-open state, and the electronic throttle device 6 shortly reaches a predetermined deceleration open degree (the target deceleration open degree TTAd) and the EGR valve 23 is fully closed.

After that, when the delayed time for valve-opening Tod has elapsed, as indicated with the solid lines in FIGS. 7 (b) and (c), the fresh-air inflow valve 32 and the intake bypass valve 12 start to open at the same time t2. In the conventional control operation, as indicated with the broken lines in FIGS. 7 (b) and (c), the fresh-air inflow valve 32 and the intake bypass valve 12 start their valve opening at the same time with the deceleration request, namely at the same with start of valve-closing of the electronic throttle device 6 and the EGR valve 23.

(Operations and Effects of Fresh-Air Inflow Control)

Thus, according to the configuration of the present embodiment, the following operations and effects to the operations and effects of the first embodiment can be obtained. Specifically, the fresh-air inflow valve 32 is opened from the valve-closed state prior to (or concurrently with) start of valve-opening of the intake bypass valve 12, and this opening of the fresh-air inflow valve 32 can be performed relatively early by the volume of the fresh air chamber 34 owing to installation of this fresh-air inflow chamber 34 in the fresh-air inflow passage 31. Therefore, the fresh air can be introduced into the intake manifold 8 relatively early without causing backflow of the EGR gas to the fresh-air inflow passage 31 from the intake manifold 8. This achieves relatively early decrease in the EGR rate to prevent misfire on the engine 1 due to deceleration.

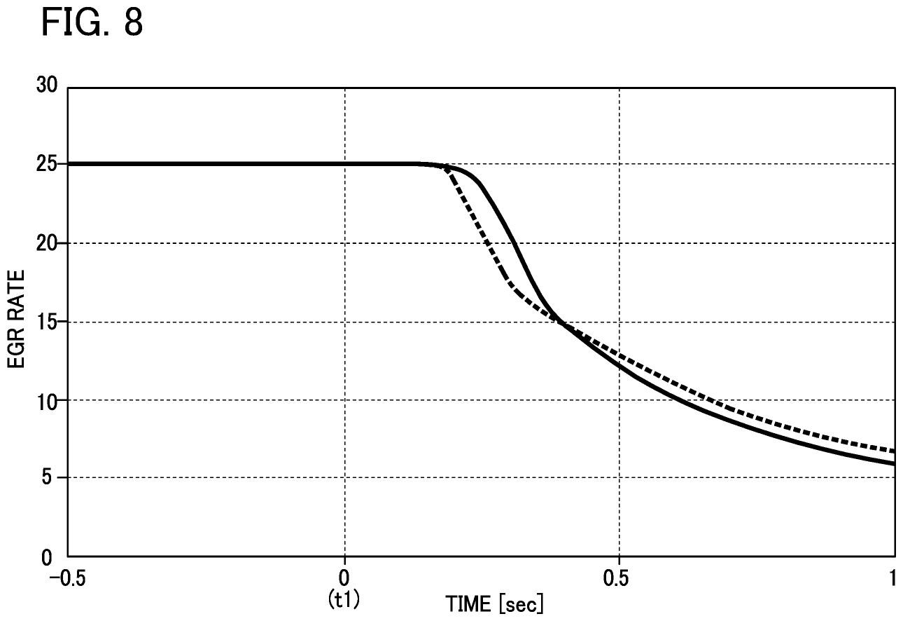

FIG. 8 is a graph showing changes in the EGR rate before and after deceleration of the engine 1. The EGR rate in this graph stands for an EGR gas ratio in each of the branch pipes 8b of the intake manifold 8 (a portion indicated with a chain-dot oblong S2 in FIG. 1) where the fresh air is to be introduced. In FIG. 8, a solid line (bold line) represents behavior of the present embodiment, and a broken line indicates conventional behavior. As shown in FIG. 8, when about “0.2 (sec)” has elapsed from time t1 when the deceleration request is made, the EGR rate, which has been stable until then, starts to decrease. In a term from time t1 to “0.4 (sec)”, the EGR rate in the conventional configuration (the broken line) is lower than the one in the present embodiment (the solid line). However, after the time “0.4 (sec)” has elapsed, the EGR rate in the present embodiment (the solid line) becomes lower than that in the conventional configuration (the broken line). This result proves the effect of pressure decrease by opening the intake bypass valve 12 concurrently with valve-opening of the fresh-air inflow valve 32 at the timing delayed by a predetermined term from valve-closing of the electronic throttle device 6 during deceleration of the engine 1.

Herein, changes in the EGR rate in a case of changing timing of opening the intake bypass valve 12 during deceleration of the engine 1 is explained for reference. The EGR rate in this explanation stands for a degree of backflow of the EGR gas to the inlet port 31a and its vicinity (the portion indicated with the chain-dot oblong S1 in FIG. 1) of the fresh-air inflow passage 31.

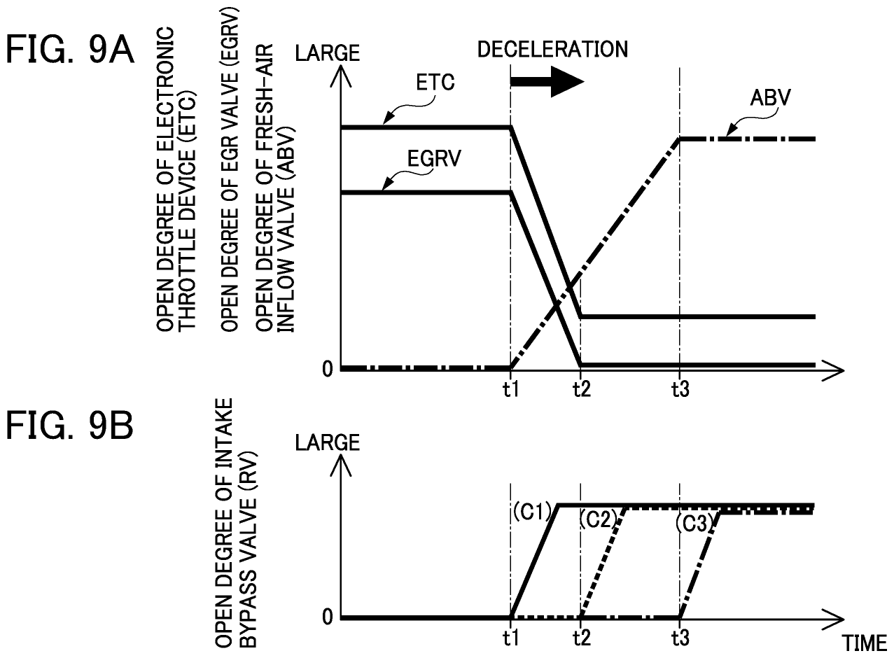

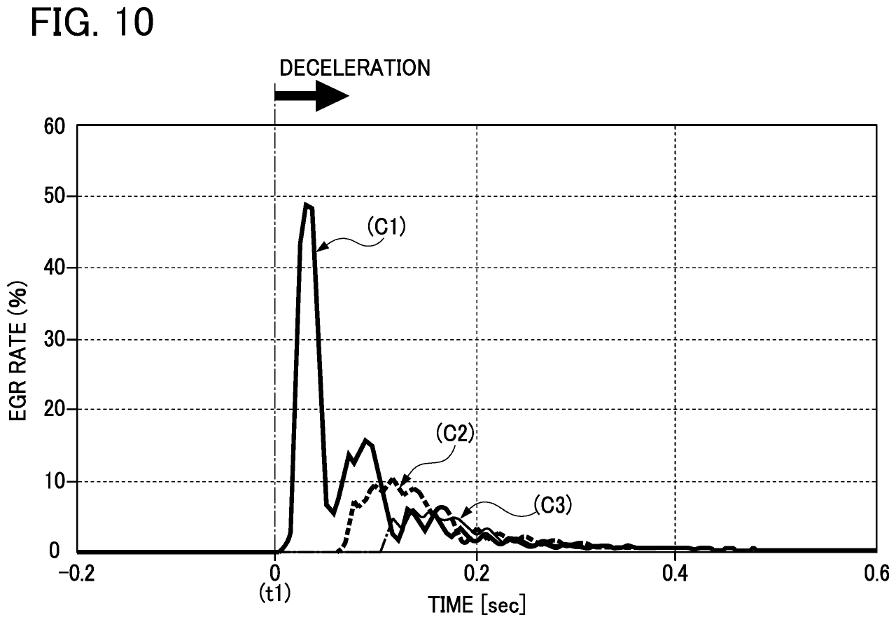

FIG. 9 is a time chart showing behavior of the various parameters for the engine control. In FIG. 9, (a) indicates open degrees of the electronic throttle device 6, the EGR valve 23, and the fresh-air inflow valve 32, and (b) indicates an open degree of the intake bypass valve 12. In this example, as shown in FIG. 9(a), when the deceleration request is received at time t1, the electronic throttle device 6 and the EGR valve 23 concurrently start to close, and at the same time, the fresh-air inflow valve 32 starts to open. In FIG. 9(b), a solid line (C1) represents a case of starting valve-opening of the intake bypass valve 12 at the same time with time t1, a broken line (C2) represents a case of starting valve-opening of the intake bypass valve 12 around time t2 when valve-closing of the electronic throttle device 6 and the EGR valve 32 have been completed, and a chain-dot line (C3) represents a case of starting valve-opening of the intake bypass valve 12 around time t3 when valve-opening of the fresh-air inflow valve 32 has been completed. FIG. 10 is a graph showing changes in the EGR rate in each of the above cases (C1) to (C3).

As shown in FIG. 10, with respect to the changes in the EGR rate on or after deceleration of the engine 1 (time t1), the EGR rate is made lower in the cases (C2) and (C3) in which the intake bypass valve 12 is opened with delay from deceleration than in the case (C1) in which the intake bypass valve 12 is opened concurrently with deceleration of the engine 1. The more the start timing of opening the intake bypass valve 12 is delayed form the start timing of deceleration, the more the degree of backflow of the EGR gas is restrained as mentioned above. It is considered that this restraint is achieved because the residual supercharging pressure decreases in the intake passage 2.

This disclosed technique is not limited to the above embodiments and may be embodied with partly changing its configuration in an appropriate manner without departing from the scope of the disclosed technique.

(1) In the above-mentioned second embodiment, on or before starting valve-opening of the intake bypass valve 12 during deceleration of the engine 1, the fresh-air inflow valve 32 is configured to open from the valve-closed state. Alternatively, the fresh-air inflow valve 32 may be configured to open from the valve-closed state after starting valve-opening of the intake bypass valve 12 during deceleration of the engine 1 (see FIG. 1). In this case, it is possible to open the fresh-air inflow valve 32 after the intake pressure PM in the intake passage 2 has been decreased by opening the intake bypass valve 12. Therefore, backflow of the EGR gas to the fresh-air inflow passage 31 from the intake manifold 8 can be restrained. Furthermore, in a case that the fresh air chamber 34 is provided in the fresh-air inflow passage 31, the volume of the chamber 34 can be made small.

(2) In the above embodiments, the predetermined period of time for delaying the timing of opening the fresh-air inflow valve 32 from valve-closing of the electronic throttle device 6, or the timing of concurrently opening the fresh-air inflow valve 32 and the intake bypass valve 12 is determined by the elapse of time, but alternatively, this predetermined period of time may be determined by changes in a crank angle of the engine 1.

(3) In the above embodiments, the predetermined period of time for delaying the timing of opening the fresh-air inflow valve 32 from valve-closing of the electronic throttle device 6, or the timing of concurrently opening the fresh-air inflow valve 32 and the intake bypass valve 12 is calculated based on the detected intake pressure PM and others, but alternatively, this predetermined period of time may be a predetermined fixed value.

(4) In the above-mentioned first embodiment, the intake bypass passage 11 and the intake bypass valve 12 are provided in the supercharger 5, but those components may be omitted.

### INDUSTRIAL APPLICABILITY

This disclosed technique can be utilized for an engine system provided with an engine, a supercharger, an intake amount regulation valve, an exhaust gas recirculation apparatus, and a fresh-air inflow unit.

### REFERENCE SIGNS LIST

1 Engine
2 Intake passage
3 Exhaust passage
5 Supercharger
5a Compressor
5b Turbine
5c Rotary shaft
6 Electronic throttle device (Intake amount regulation valve)
6a Throttle valve
11 Intake bypass passage
12 Intake bypass valve
21 EGR apparatus (Exhaust gas recirculation apparatus)
22 EGR passage (Exhaust gas recirculation passage)
22a Inlet port
22b Outlet port
23 EGR valve (Exhaust gas recirculation valve)
30 Fresh-air inflow unit
31 Fresh-air inflow passage
31a Inlet port
32 Fresh-air inflow valve
34 Fresh air chamber
51 Throttle sensor (Operation state detection member)
52 Air flowmeter (Intake amount detection member, Operation state detection member)
53 Intake pressure sensor (Operation state detection member)
54 Water temperature sensor (Operation state detection member)
55 Rotation speed sensor (Operation state detection member)
56 Oxygen sensor (Operation state detection member)
57 Accelerator sensor (Operation state detection member)
60 ECU (Control unit)

1. Engine system comprising:
an engine;
an intake passage configured to introduce intake air into the engine;
an exhaust passage configured to allow exhaust gas to flow out of the engine;
a supercharger provided in the intake passage and the exhaust passage to increase pressure of the intake air in the intake passage,
the supercharger including a compressor placed in the intake passage, a turbine placed in the exhaust passage, and a rotary shaft integrally rotatably connecting the compressor and the turbine;
an intake amount regulation valve placed in the intake passage downstream of the compressor to regulate an intake amount of the intake air flowing in the intake passage;
an exhaust gas recirculation apparatus including an exhaust gas recirculation passage configured to allow a part of the exhaust gas discharged from the engine to the exhaust passage to flow in the intake passage as exhaust gas recirculation gas and an exhaust gas recirculation valve configured to regulate an exhaust gas recirculation flow rate in the exhaust gas recirculation passage,
the exhaust gas recirculation passage having an inlet connected to the exhaust passage downstream of the turbine and an outlet connected to the intake passage upstream of the compressor;
a fresh-air inflow unit including a fresh-air inflow passage configured to introduce fresh air to the intake passage downstream of the intake amount regulation valve and a fresh-air inflow valve configured to regulate a fresh air amount of fresh air flowing in the fresh-air inflow passage,
the fresh-air inflow passage having an inlet port connected to the intake passage upstream of the outlet of the exhaust gas recirculation passage;
an operation state detection member configured to detect an operation state of the engine; and
a control unit configured to control at least the intake amount regulation valve, the exhaust gas recirculation valve, and the fresh-air inflow valve based on the detected operation state of the engine, wherein
the control unit is configured to close the intake amount regulation valve to a predetermined deceleration open degree from a valve open state so that the intake amount of the intake air to the engine is narrowed, to close the exhaust gas recirculation valve so that the inflow of the exhaust gas recirculation gas to the intake passage is shut off, and to open the fresh-air inflow valve from the valve closed state at a timing delayed by a predetermined period of time from a timing of closing the intake amount regulation valve so that a fresh air is introduced into the intake passage downstream of the intake amount regulation valve.

2. The engine system according to claim 1, wherein
the engine system further comprises an intake pressure detection member for detecting an intake pressure in the intake passage downstream of the intake amount regulation valve, and
the control unit is configured to calculate the predetermined period of time for delaying valve-opening of the fresh-air inflow valve based on the detected intake pressure, a volume of the intake passage downstream of the intake amount regulation valve, and a volume of the fresh-air inflow passage.

3. The engine system according to claim 1, wherein the engine system is provided with a chamber having a predetermined volume in the fresh-air inflow passage upstream of the fresh-air inflow valve.

4. The engine system according to claim 3, wherein
the engine system further comprises:
an intake bypass passage bypassing an upstream side and a downstream side of the compressor; and
an intake bypass valve to open and close the intake bypass passage, and
the control unit is configured to open the fresh-air inflow valve from the valve-closed state on or prior to start of valve opening of the intake bypass valve.

5. The engine system according to claim 1, wherein
the engine system further comprises:
an intake bypass passage bypassing an upstream side and a downstream side of the compressor; and
an intake bypass valve configured to open and close the intake bypass passage, and
the control unit is configured to open the fresh-air inflow valve from the valve-closed state after start of valve-opening of the intake bypass valve.

6. The engine system according to claim 2, wherein the engine system is provided with a chamber having a predetermined volume in the fresh-air inflow passage upstream of the fresh-air inflow valve.

7. The engine system according to claim 6, wherein
the engine system further comprises:
an intake bypass passage bypassing an upstream side and a downstream side of the compressor; and
an intake bypass valve to open and close the intake bypass passage, and
the control unit is configured to open the fresh-air inflow valve from the valve-closed state on or prior to start of valve opening of the intake bypass valve.

8. The engine system according to claim 2, wherein
the engine system further comprises:
an intake bypass passage bypassing an upstream side and a downstream side of the compressor; and
an intake bypass valve configured to open and close the intake bypass passage, and
the control unit is configured to open the fresh-air inflow valve from the valve-closed state after start of valve-opening of the intake bypass valve.

9. The engine system according to claim 3, wherein
the engine system further comprises:
an intake bypass passage bypassing an upstream side and a downstream side of the compressor; and
an intake bypass valve configured to open and close the intake bypass passage, and
the control unit is configured to open the fresh-air inflow valve from the valve-closed state after start of valve-opening of the intake bypass valve.

10. The engine system according to claim 6, wherein
the engine system further comprises:
an intake bypass passage bypassing an upstream side and a downstream side of the compressor; and
an intake bypass valve configured to open and close the intake bypass passage, and
the control unit is configured to open the fresh-air inflow valve from the valve-closed state after start of valve-opening of the intake bypass valve.
